(19) United States
(12) Patent Application Publication
(10) Pub. No.: US 2024/0079654 A1
(43) Pub. Date: Mar. 7, 2024

(54) ETHER-BASED ELECTROLYTES FOR LITHIUM METAL BATTERIES, LITHIUM METAL BATTERIES, AND METHODS OF USE

(71) Applicant: Purdue Research Foundation, West Lafayette, IN (US)

(72) Inventors: Vilas G. Pol, West Lafayette, IN (US); Zheng Li, Greenbelt, MD (US)

(21) Appl. No.: 18/458,853

(22) Filed: Aug. 30, 2023

Related U.S. Application Data
(60) Provisional application No. 63/402,752, filed on Aug. 31, 2022.
(60) Provisional application No. 63/486,135, filed on Feb. 21, 2023.

(51) Int. Cl. H01M 10/0569; H01M 4/38; H01M 4/505; H01M 4/525; H01M 10/052; H01M 10/0568; H01M 10/42

(52) U.S. Cl. CPC H01M 10/0569; H01M 4/382; H01M 4/505; H01M 4/525; H01M 10/052; H01M 10/0568; H01M 10/4235; H01M 2300/0028

(57) ABSTRACT

Ether-based electrolytes for lithium metal batteries, lithium metal batteries, and methods of their use. Such an ether-based electrolyte includes a highly-nonpolar, nonfluorinated dipropyl ether (DPE) solvent that enhances the oxidation stability of a lithium metal battery. Such a lithium metal battery includes the ether-based electrolyte electrochemically coupling an anode and cathode of the battery.

### CROSS-REFERENCE TO RELATED APPLICATIONS

This application claims the benefit of U.S. Provisional Application No. 63/402,752 filed Aug. 31, 2022, and U.S. Provisional Application No. 63/486,135 filed Feb. 21, 2023, the contents of each of which are incorporated herein by reference.

### BACKGROUND OF THE INVENTION

The present invention generally relates to lithium metal batteries (LMBs). The invention particularly relates to ether-based electrolytes for lithium metal batteries, lithium metal batteries, and methods of using ether-based electrolytes.

Pairing lithium (Li) metal anodes (LMA) with high voltage nickel-rich (Ni-rich) Li(NiₓCo_{y}Mn_{1-x-y})O₂ (NCM) cathodes for next-generation Li metal batteries (LMBs) is one of the most promising approaches for increasing the energy density of LMBs to meet the ever-increasing demand for electric energy storage. However, LMAs suffer from problematic cyclability due to a dramatic volume change and dendritic deposition. The continuous cracking and regeneration of the solid electrolyte interface (SEI) consume the anode and the liquid electrolyte, leading to “Dead Li” formation that accelerates capacity loss and mechanical pulverization. Meanwhile, severe electrolyte oxidation and other parasitic reactions at the cathode electrolyte interface (CEI) of Ni-rich NCM cathodes also promotes battery failure. Designing novel electrolytes is generally the most efficient pathway for tuning LMBs' interfacial behaviors, mitigating side reactions to enable their long-term operation.

Electrolytes containing ether solvents (ether-based electrolytes) such as 1,2-Dimethoxyethane (DME) give rise to better LMA compatibility (Coulombic efficiency (CE)) as compared to conventional carbonates. However, the intrinsic oxidation instability of ether solvents has prevented high-voltage battery applications above 4 V. In addition, dilute ether-based electrolytes with imide-type salts, such as lithium bis(fluorosulfonyl) imide (LiFSI) or lithium bis(trifluoromethanesulfonic)imide (LiTFSI), corrode aluminum (Al) current collectors above 3.8 V and deteriorate battery performance. Several strategies have been reported to improve the oxidation stability of ether solvents. Ultra-high concentrated (>4 M) ether-based electrolytes (HCE) containing minimal free solvent molecules have significantly extended their anodic potential window. Anion-involved solvation structure adjusts the CEI chemistry, generating an inorganic-rich passivation layer that prevents further decomposition. Incorporating noncoordinating hydrofluoroethers (HFEs) into an HCE as diluents can preserve the Li+ solvation environment while simultaneously dividing large ion aggregates into small clusters to reduce the viscosity, yielding the concept of locally high concentrated electrolyte (LHCE). Additionally, molecular engineering via partially fluorinating ether molecules can intrinsically improve ethers' anodic stability and tune the SEI/CEI composition for improved stability.

However, the abovementioned pathways inevitably increase the manufacturing cost of the electrolyte. The high density of HFEs (>1.4 g/cm³) also has an adverse impact on energy density. The uncertain environmental effects of fluorinated ethers could be potential obstacles to large-scale commercialization. Therefore, designing optimal electrolytes to overcome anodic stability issues of ethers via facile and cost-effective approaches should be considered, despite the rarely reported stable high-voltage LMB with dilute nonfluorinated ether.

The prerequisites for building stable ether-based electrolytes are still unclear. The improved performance has been attributed to cathode passivation, molecular stability, Al corrosion, and solvation structure, but the correlations among these crucial factors have been seldom elucidated. The fundamental oxidation behavior of dilute ether-based electrolytes on a molecular level and their interfacial evolutions at high-voltage cathodes have not been fully interpreted. These ambiguities hinder the precise design of new ether-based electrolyte systems, especially with low salt concentration.

The solvation behavior of electrolytes and its correlation with battery performance have been investigated. Specifically, several works have reported weakly-solvated ether-based electrolytes (WSEE) featuring an anion-involved solvation environment with low concentration. Less polar ethers compared to conventional glyme-based ethers allow suppressed Li+-solvent interactions and lead to the formation of contact ion pairs (CIPs) in the solution without implementing high salt concentration. Some improved oxidation stabilities have been identified with dilute WSEEs. For example, Holoubek et al., Nat. Energy 2021, DOI 10.1038/s41560-021-00783-z, observed better stability of 1 M diethyl ether (DEE) on an Al electrode and attributed it to CIP structures. Chen et al., Am. Chem. Soc. 2021, 143, 18703-18713, and Pham et al., Small 2022, 2107492, 1-15, have separately reported improved performance of 1,2-diethoxyethanes over DME under highly concentrated conditions due to anion-enriched solvation, resulting in better CEI. However, all studied WSEE systems still failed to deliver satisfactory NCM cathode compatibility without using high concentrations.

In view of the above, there are certain limitations or shortcomings associated with existing ether-based electrolytes that hinder their practical applications in high-voltage LMBs. Therefore, it would be desirable if new pathways were available that were capable of intrinsically lessening the Li+-solvent interaction strength of a dilute ether-based electrolyte to at least partly overcome or avoid the limitations or shortcomings associated with existing ether-based electrolytes.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, ether-based electrolytes for lithium metal batteries (LMBs), lithium metal batteries including an ether-based electrolyte, and methods of using an ether-based electrolyte as a battery electrolyte of a lithium metal battery.

According to a nonlimiting aspect of the invention, an ether-based electrolyte is provided for a lithium metal battery. The ether-based electrolyte includes a highly-nonpolar, nonfluorinated dipropyl ether (DPE) solvent that enhances the oxidation stability of the lithium metal battery.

According to other nonlimiting aspects of the invention, a lithium metal battery is provided. The lithium metal battery includes an anode, a cathode, and an ether-based electrolyte electrochemically coupling the anode with the cathode. The ether-based electrolyte includes a highly-nonpolar, nonfluorinated dipropyl ether (DPE) solvent that enhances the oxidation stability of the lithium metal battery.

According to yet other nonlimiting aspects of the invention, a method is provided that includes using an ether-based electrolyte as a battery electrolyte of a lithium metal battery, wherein the ether-based electrolyte includes a highly-nonpolar, nonfluorinated dipropyl ether (DPE) solvent that enhances the oxidation stability of the lithium metal battery.

Technical aspects of ether-based electrolytes as described above preferably include the capability of enhancing the oxidation stability of lithium metal batteries by intrinsically lessening the Li+-solvent interaction strength of a dilute (e.g., <2 M or <3 M) ether-based electrolyte to achieve stable high-voltage cathode cycling.

Other aspects and advantages will be appreciated from the following detailed description as well as any drawings.

### BRIEF DESCRIPTION OF THE DRAWINGS

FIGS. 1A-1F graphically depict ether-based electrolytes with decreasing solvating power and their anodic stability. FIG. 1A contains electrostatic potential (ESP) maps of ether molecules of four evaluated dilute ether-based electrolytes and their corresponding dielectric constants. FIG. 1B contains a graph plotting viscosity and surface tension values of the four evaluated electrolytes and solvents of FIG. 1A. FIG. 1C contains a graph plotting results of linear scanning voltammetry (LSV) of the dilute ether-based electrolytes with an Al working electrode in Li—Al coin cells at a scan rate of 0.5 mV/s. FIG. 1D contains a graph plotting the coulombic efficiencies of Li-NCM811 coin cells cycled between 2.8 V and 4.3 V at 0.48 mA/cm² with the dilute ether-based electrolytes and a cathode loading of about 8.3 mg/cm². FIG. 1E contains a graph plotting results of chronoamperometry testing of Li-NCM811 coin cells at 4.3 V. FIG. 1F contains a graph plotting results of long-term cycling performance of Li-NCM811 coin cells at 1.6 mAh/cm² in which two formation cycles at 0.16 mA/cm² and 0.8 mA/cm² were performed.

FIGS. 2A-2H graphically depict solvation environments of the four evaluated dilute ether-based electrolytes. FIGS. 2A, 2B, and 2C contain graphs plotting the radial distribution functions of interactions between Li+ to solvent (FIG. 2A), Li+ to FSI− (FIG. 2B) and Li+ to Li+ (FIG. 2C). FIG. 2D graphically represent MD simulation boxes of the four evaluated dilute ether-based electrolytes. FIG. 2E contains graphs plotting the concentration-dependent Raman spectra of electrolytes with salt to solvent ratios from 1:1 (1:2 for the DPE and DEE; bottom) to 1:9 (top). FIG. 2F contains graphs plotting the deconvolution analyses of S—N—S Raman spectroscopy signals from 1.8 M electrolytes. FIGS. 2G and 2H contain graphs plotting, respectively, the ⁷Li NMR spectra and atomic coordination numbers of the four evaluated dilute ether-based electrolytes.

FIGS. 3A and 3B graphically depict cathode passivation layer characterizations of the four evaluated dilute ether-based electrolytes. FIG. 3A contains graphs plotting the XPS fine spectra deconvoluting analyses of C 1s, F 1s, and O 1s signals from the dilute ether-based electrolytes. FIG. 3B contains a graph plotting the results of an electrolyte exchange study between DPE and DME with a schematic illustration of the positive electrode with exchanged electrolytes. FIG. 3C contains high-resolution TEM imaging of CEI layers on cycled cathodes. Scale bars are 10 nm.

FIGS. 4A-4F graphically depict results of a theoretical study of electrolyte stability and interfacial models of the four evaluated dilute ether-based electrolytes. FIG. 4A contains a graph plotting the calculated LUMO-HOMO energy levels of solvent and top-two most probable solvation species in the dilute ether-based electrolytes. FIG. 4B contains a graph plotting the number densities of the ether solvent molecules in the inner Helmholtz layer under an applied potential via MD simulation. FIGS. 4C and 4D schematically depict, respectively, the DPE and DME-containing electrolyte components in the EDL at the cathode surface. FIGS. 4E and 4F schematically depict, respectively, the interfacial model of WSEEs and polar ether-based electrolytes at the NCM cathode surface.

FIGS. 5A-5D graphically depict results of a Li anode efficiency study with interfacial characterization and modeling of the four evaluated dilute ether-based electrolytes. FIG. 5A contains a graph plotting the coulombic efficiency determined by a modified Aurbach method under 0.5 mA/cm² current density. Formation cycles are omitted. FIG. 5B contains a graph plotting the extended long cycling of Li—Cu cells at 0.5 mA/cm² and 1 mAh/cm². Data points between cycle 100 and 300 are shown in the zoomed-in inset. FIG. 5C contains graphs plotting the XPS analyses of depth-dependent elemental concentration on Li anodes after 100 half-cell cycles. FIG. 5D contains graphs plotting the depth-dependent S 2p XPS spectra of cycled LMA from the evaluated dilute ether-based electrolytes. The spectra from bottom to top represent increasing argon plasma etching depth.

FIGS. 6A-6F graphically depict results of practical Li metal battery cycling of the four evaluated dilute ether-based electrolytes under different conditions. FIG. 6A contains a graph plotting results of a long cycling study of the full cells with N/P ratio=2, E/C ratio=8 g/Ah. Electrochemically plated Li anodes under 0.5 mA/cm² for 12 h were used as the anode. A 50-micrometer Li foil was used for the DIG-containing electrolyte due to its lower plating efficiency. FIG. 6B contains a graph plotting long cycling of anode-free, Cu-NCM811 cells. In FIGS. 6A and 6B, two formation cycles were performed with 0.1 C and following cycles with 0.3 C charge, 0.5 C discharge. FIGS. 6C and 6D contain graphs plotting results of a lean electrolyte study with N/P ratio=2, E/C ratio=3 g/Ah and voltage profiles of the DPE-containing electrolyte. FIGS. 6E and 6F contain graphs plotting results of a long cycle demonstration and cycling profiles.

FIG. 7 graphically compares characteristics of ether molecules of DME, DEE, and FEME.

FIGS. 8, 9, and 10 contain graphs comparing the electrochemical performance of DME, DEE, and FEME-containing electrolytes.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

Inferior oxidation stability of ether-based electrolytes has hindered their practical applications in high-voltage Li metal batteries (LMBs). Herein, a pathway is disclosed via intrinsically lessening the Li+-solvent interaction strength of a dilute (<2 M or <3 M) ether-based electrolyte to achieve stable high-voltage cathode cycling. In investigations leading to the present invention, electrolytes containing highly nonpolar dipropyl ether (DPE) as a solvent were determined to circumvent the oxidation of free ether molecules by the preferential decomposition of strongly aggregated Li-anion clusters, due to the rearranged decomposition order of solvate species. As a result, a robust anion-derived cathode electrolyte interface can be selectively generated despite the existence of an abundance of free ether molecules. A solvent-deficient electric double layer can also form to synergistically prevent the ether oxidation. As a result, the dilute DPE-containing electrolyte is capable of ultra-high coulombic efficiency (99.90%, 4.3 V) of high loading a Ni-rich cathode and stable cycling of a practical LMB (82%, after 220 cycles) combined with a 99.4% Li metal anode efficiency. Correlations between the ether coordination strength and their high voltage compatibilities was also demonstrated.

In the investigations, dilution strategy was used to lose the Li+/solvent interaction and use the dilute non-aqueous electrolyte solution in high-voltage lithium metal batteries. In some nonlimiting aspects using a non-polar dipropyl ether (DPE)-based electrolyte solution with lithium bis(fluorosulfonyl) imide salt, the decomposition order of solvated species can be adjusted to promote the Li+/salt-derived anion clusters decomposition over free ether solvent molecules. This selective mechanism favors the formation of a robust cathode electrolyte interphase (CEI) and a solvent-deficient electric double-layer structure at the positive electrode interface. When the DPE-based electrolyte is tested in combination with a Li metal negative electrode (50 μm thick) and a LiNi0.8Co0.1Mn0.1O2-based positive electrode (3.3 mAh/cm2) in pouch cell configuration at 25° C., a specific discharge capacity retention of about 74% after 150 cycles (0.33 and 1 mA/cm2 charge and discharge, respectively) is obtained.

The high voltage compatibility of dilute ether-based electrolytes with decreasing solvating power was systematically explored to demonstrate the feasibility of stable high-voltage LMBs with weakly coordinating solvents. For this purpose, a series of regular nonfluorinated ether solvents, including diglyme (DIG), 1,2-Dimethoxyethane (DME), diethyl ether (DEE), and dipropyl ether (DPE), were investigated. Low concentrations (1.8 M LiFSI) of ether-based electrolyte were demonstrated to successfully endure long-term high voltage (4.3 V) operations of practical LMBs (with controlled negative/positive (N/P) ratios and lean electrolytes) when using the highly nonpolar ether solvent DPE. Also confirmed were correlations between dilute ether-based electrolytes' solvation behavior and their stability on a high-voltage NCM811 cathode, including oxidation pathways, passivation behaviors, and Al current collector corrosion. The correlations were further interpreted via detailed classical molecular dynamics (MD) simulations and density functional theory (DFT) calculations coupled with multimodal experimental analyses. It was demonstrated that improving the compatibility of ether-based electrolytes with high voltage cathodes does not necessarily require thermodynamically improved oxidation stability via conventional approaches, such as diminishing uncoordinated ether molecules or introducing molecular fluorination. Rearranging the degradation order of solvation species in the electrolyte and adjusting the composition of the electric double layer on the cathode surface can kinetically stabilize the electrode-electrolyte interface with equal or even better effect than reported results.

In some nonlimiting embodiments of the invention, an ether-based electrolyte for a lithium metal battery includes a highly-nonpolar, nonfluorinated dipropyl ether (DPE) solvent that enhances the oxidation stability of the lithium metal battery. The DPE solvent may enhance the oxidation stability by adjusting the interfacial decomposition sequence and modifying the electric double layer structure of the lithium metal battery. The ether-based electrolyte may include an imide type salt, such as lithium bis(fluorosulfonyl) imide (LiFSI) or lithium bis(trifluoromethanesulfonic)imide (LiTFSI). The imide type salt preferably has a concentration in the ether-based electrolyte of less than 3 M (3 molar), in some cases less than 2 M (3 molar).

In other nonlimiting embodiments of the invention, a lithium metal battery includes an ether-based electrolyte electrochemically coupling an anode with a cathode. The ether-based electrolyte includes a highly-nonpolar, nonfluorinated dipropyl ether (DPE) solvent as described herein that enhances the oxidation stability of the lithium metal battery. Preferably, the battery operates at a voltage of greater than 4 V, for example, 4.3 V, or higher than 4.3 V. The cathode may be or include a nickel rich cathode. In some arrangements, the anode includes a lithium metal negative electrode, and/or the cathode includes a LiNi0.8Co0.1Mn0.1O2-based positive electrode.

In further nonlimiting embodiments of the invention, a method includes using an ether-based electrolyte as a battery electrolyte of a lithium metal battery, wherein the ether-based electrolyte comprises a highly-nonpolar, nonfluorinated dipropyl ether (DPE) solvent that enhances the oxidation stability of the lithium metal battery. The method may also include forming a solvent deficient electric double layer on a cathode surface of the battery using the ether-based electrolyte to inhibit oxidation of the ether-based electrolyte.

Additional nonlimiting optional embodiments and/or features of the invention will now be described in reference to some of the experimental investigations leading up to the invention.

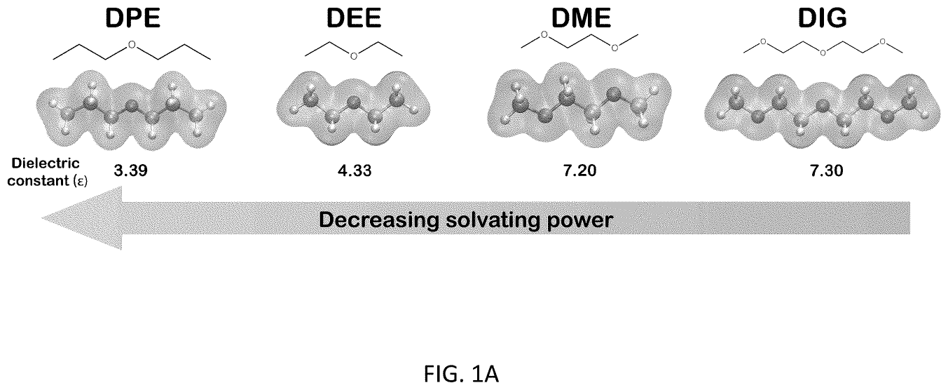

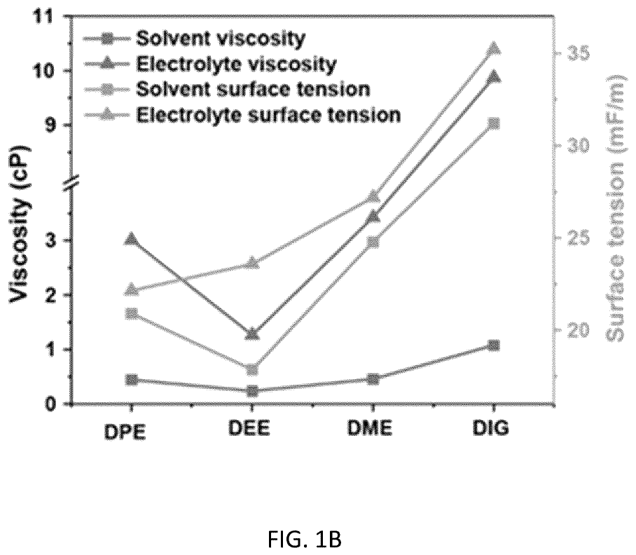

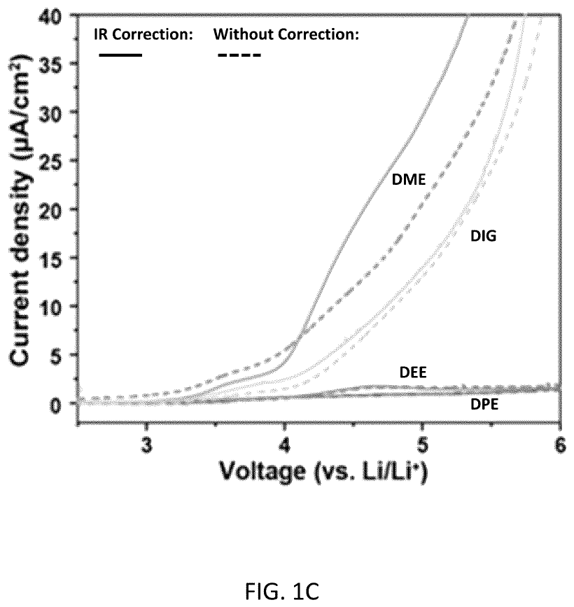

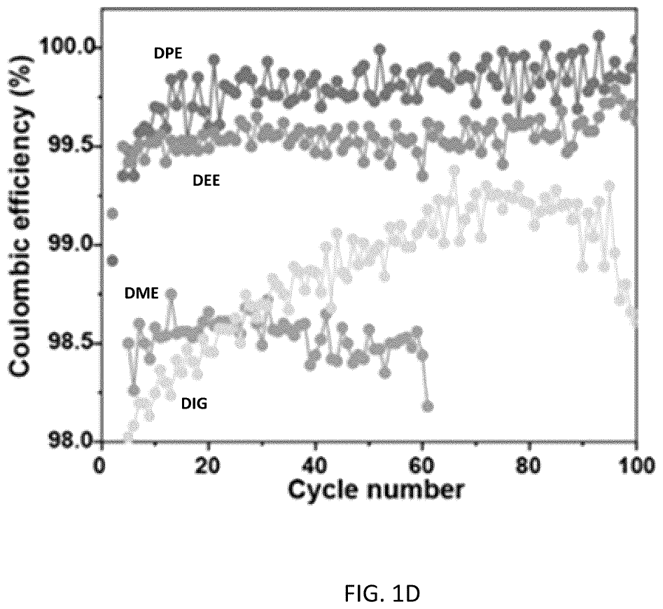

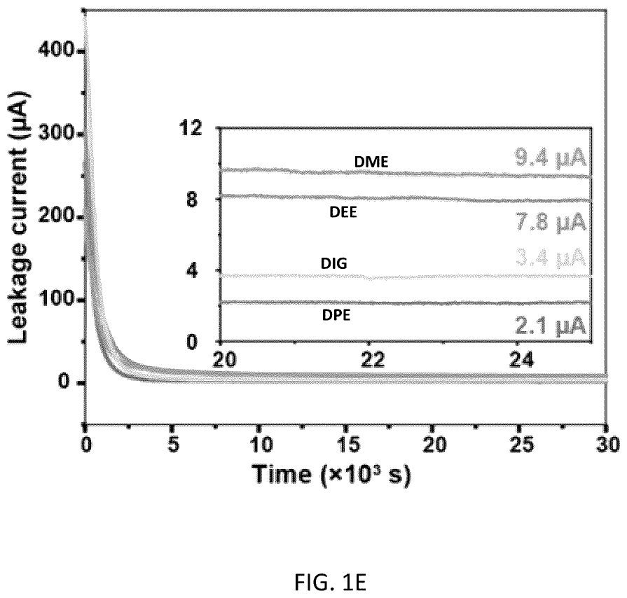

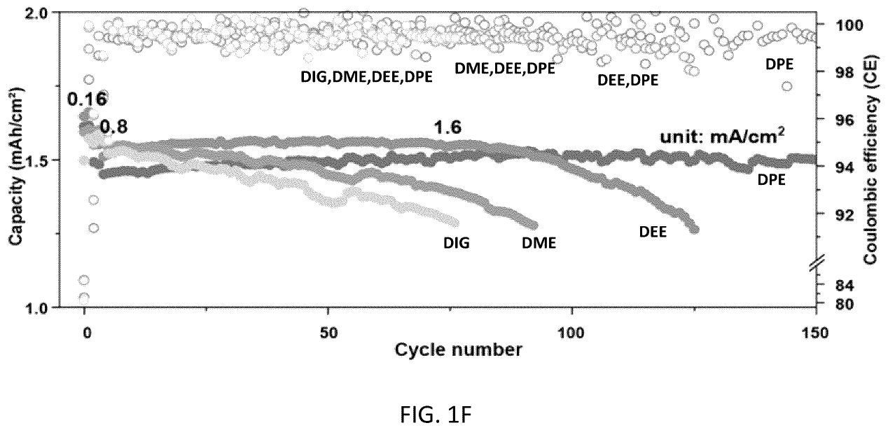

A series of common non-fluorinated ethers including DPE, DEE, DME, and DIG were evaluated as representatives of mono-, bi-, and tri-dentate ethers possessing an increasing chelating effect to Li+ in the electrolyte (FIG. 1A). Compared to DEE, the DPE molecule has longer alkyl groups and thus weaker coordinating ability due to stronger steric hindrance. The decreasing dielectric constant of the molecules also indicates increasing nonpolarity. Therefore, the four ethers with the solvating power order of DPE<DEE<DME<DIG were investigated regarding their high-voltage compatibility. FIG. 1B contains a graph plotting viscosity and surface tension values of the four evaluated electrolytes and solvents of FIG. 1A. In FIGS. 1C, 1D, and 1E, the four electrolytes with 1.8 M LiFSI salt were subjected to preliminarily anodic stability tests, where dramatically improved high-voltage performance was surprisingly demonstrated with low polarity ethers. Linear scanning voltammetry (LSV) was conducted with an Al electrode. FIG. 1C shows that both DEE and DPE exhibited stability up to 5.8V with minimal anodic current generation, while DME and DIG-containing electrolytes displayed intensive oxidation reactions from 4.5V and 4.1V, respectively. More importantly, applying the four electrolytes to Li-NCM811 (1.6 mAh/cm²) half cells generated stark differences in the cathode CE (FIG. 1D). The 1.8 M DPE-containing electrolyte shows an unprecedented high average efficiency of 99.92%, which has been seldom reported with dilute nonfluorinated ether-based electrolytes. DEE also displayed a much-improved CE of 99.58% compared to the 1.8 M DME (98.54%) and DIG (98.72%) electrolytes. A chronoamperometry study of half cells at 4.3 V (FIG. 1E) identified the lowest anodic leakage current (2.1 μA) from the DPE-containing electrolyte, with the order of DPE<DEE<DIG<DME. The extraordinary high-voltage compatibility of the DPE-based electrolyte is also comparable to other reported state-of-the-art electrolytes, which is even higher than 4.8M concentrated DME-containing electrolyte. FIG. 1F contains a graph plotting results of long-term cycling performance of Li-NCM811 coin cells at 1.6 mAh/cm² in which two formation cycles at 0.16 mA/cm² and 0.8 mA/cm² were performed. These results suggested strong correlations between electrolyte stability and solvent solvating power. Therefore, their solvation structures were identified as a priority to help in interpreting the different performance.

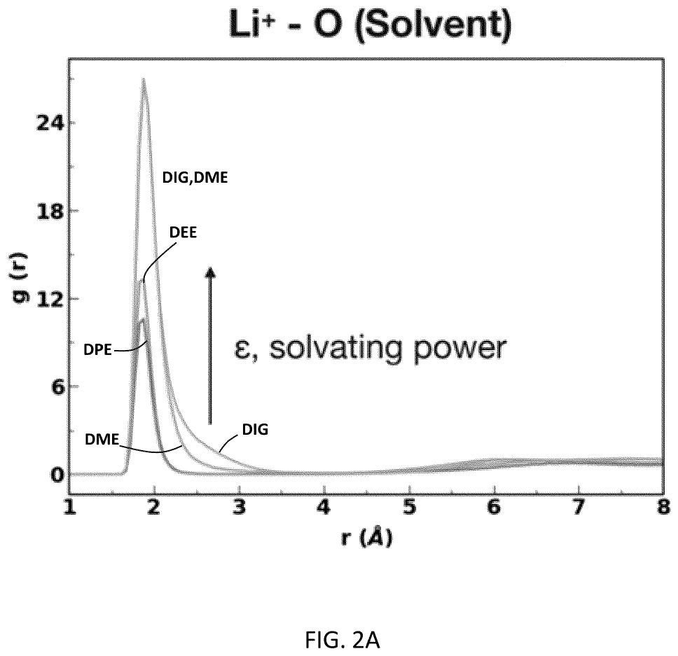

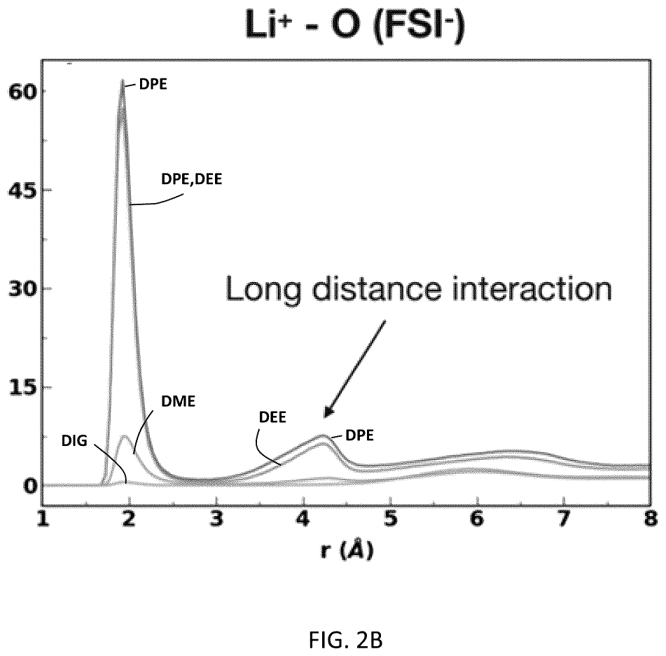

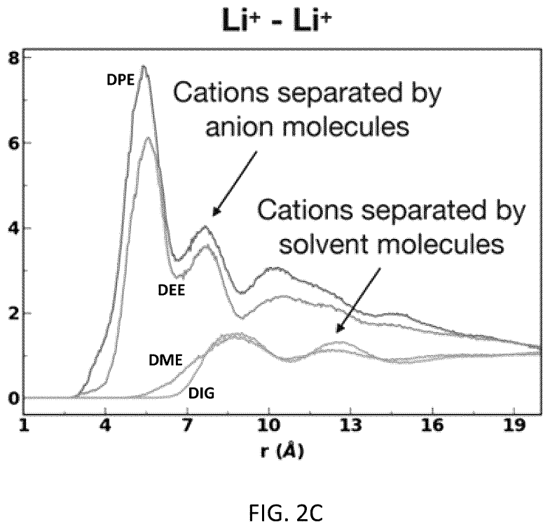

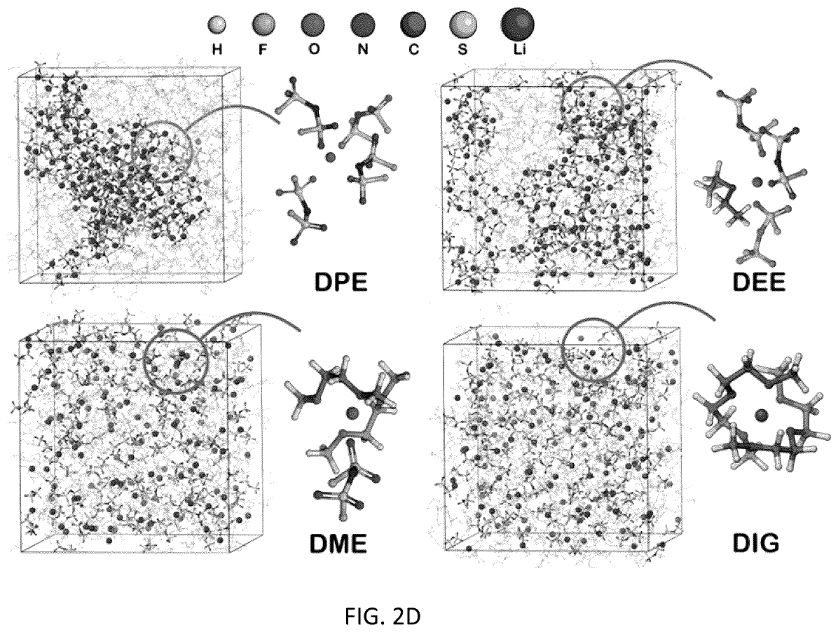

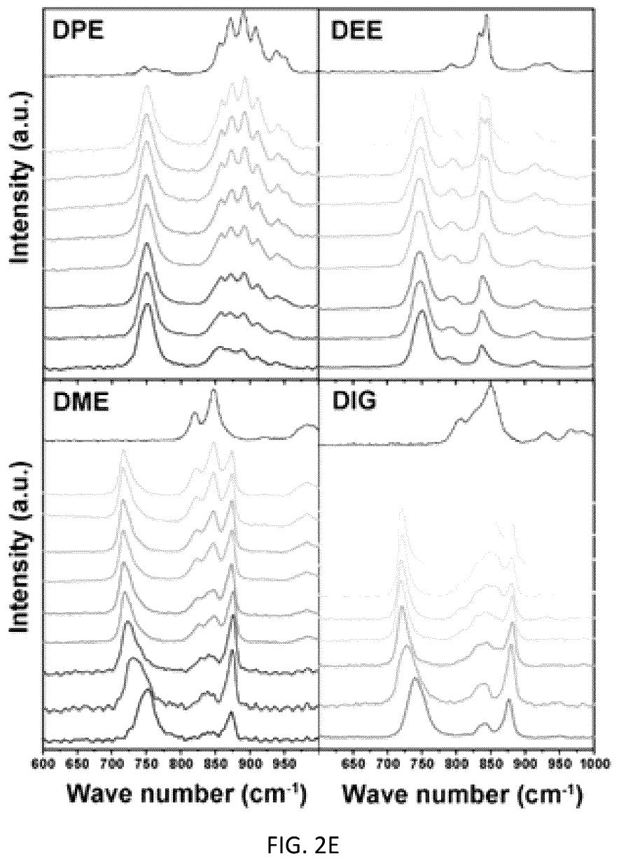

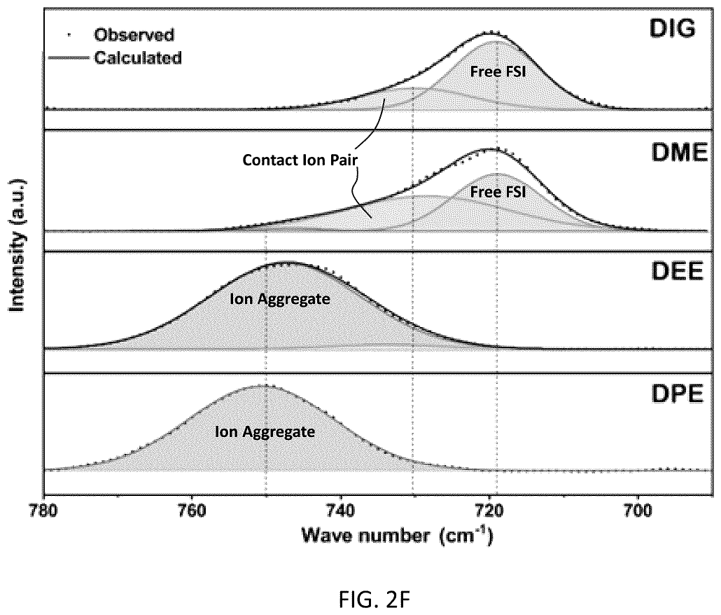

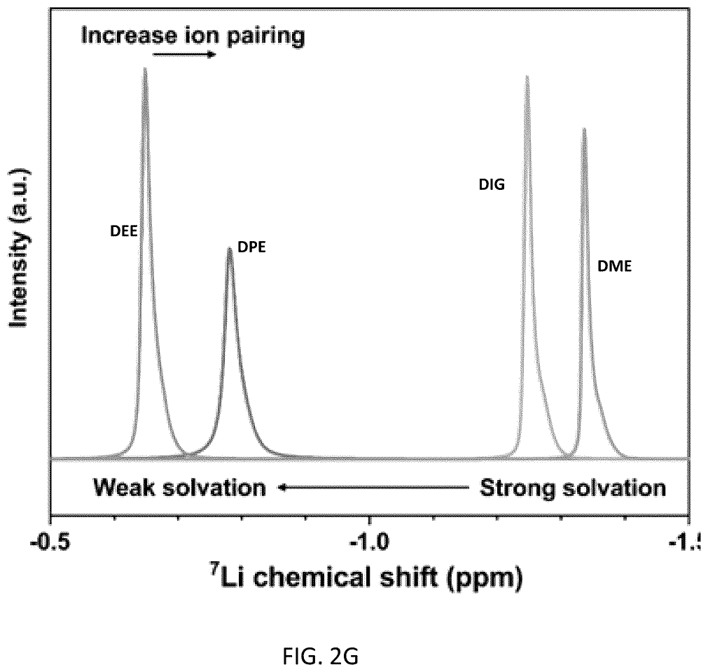

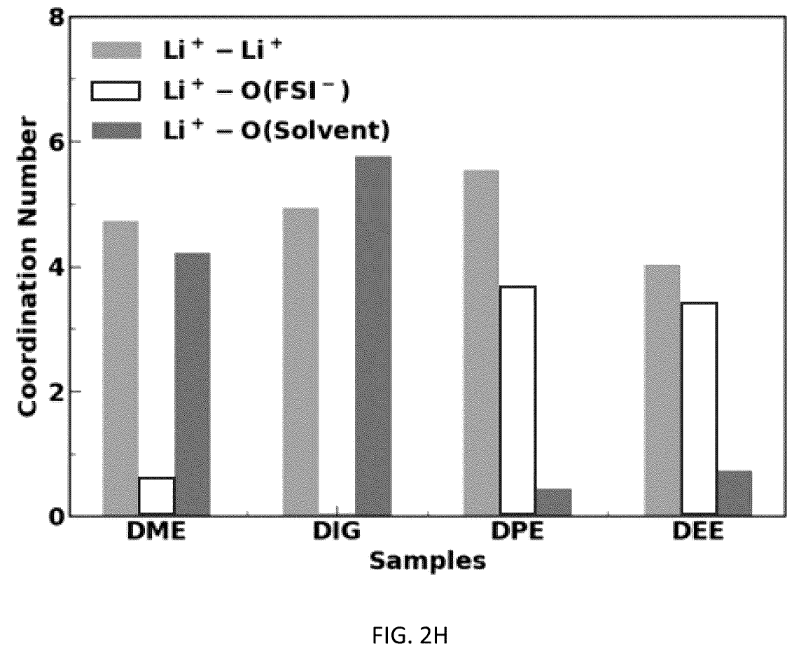

The solvation structures of the 1.8 M LiFSI ether-based electrolytes with decreasing solvent solvation power were investigated via classical MD simulations. Radial distribution functions (RDF) of solvation structures are shown in FIGS. 2A, 2B, and 2C. The Li+-solvent and Li+-FSI− interactions exhibited opposite trends in each electrolyte system. Polar DME and DIG solvents strongly coordinated with the cation, as evident from the sharp RDF peaks in these systems. In contrast, negligible Li+-FSI− RDF peaks indicated that the anion does not contribute significantly to the Li+ solvation structure, especially in the DIG-containing electrolyte. On the other hand, the nonpolar DPE and DEE ethers exhibited weak solvating power that enables Li+ to strongly interact with the anion in the primary solvation shell (r≈1.8 Å). It is worth noting that the strength of the Li+-solvent interactions increased monotonically with the solvent dielectric constant. Additionally, shorter interaction distances between Li+ ions in the weakly-solvated ether-based electrolytes (WSEE) systems (FIG. 2C) suggested the formation of large ion aggregates (AGGs) consisting of multiple Li+ and FSI− species. The aggregate formation was driven by bridging coordination of FSI− anions across multiple Li+ cations through the oxygen atoms.

Such aggregation behavior was also confirmed by the long-distance Li+-FSI− interactions within the secondary solvation shell (r≈4.2 Å), as shown in FIG. 2B. On the other hand, the cations are much more separated in polar ethers since they are tightly wrapped by solvent molecules (solvent separated ion pairs; SSIPs) due to their competitive coordination. The images of each simulation box in FIG. 2D also provide theoretical confirmation of this structural behavior. DME and DIG-containing electrolytes feature homogeneously dispersed SSIPs, anions, and free ether molecules. In contrast, DEE shows a slightly localized accumulation of CIPs and AGGs, while Li+-FSI− pairs strongly aggregate in DPE, the highest nonpolar ether among the studied solvents. Due to the pronounced AGGs, the conductivities of DPE and DEE-containing electrolytes are also obviously reduced. The most probable solvation structures extracted from MD simulations (FIG. 2D) suggested that Li+ is most likely to be coordinated with four anions (36.6% occurrence) in the DPE-containing electrolyte and three anions and one solvent molecule (46.4% occurrence) in the DEE-containing electrolyte. Instead, the Li+ solvation shell in the DME-based electrolyte most likely (45.7% of occurrence) contains two solvent molecules and one anion at the studied concentration, while the Li+ is completely chelated by DIG molecules, with an average coordination number of six DIG oxygens.

Raman spectroscopy and nuclear magnetic resonance (NMR) analyses were performed on each system to confirm the solvation structures experimentally. In FIG. 2E, Raman spectra of each ether with increasing salt concentration (molar ratio of salt to solvent from 1:9 to 1:1) were collected from the region containing FSI− S—N—S (about 700 to about 780 cm-1) and ether C—O—C vibrations (800 to 950 cm⁻¹). The higher position of the S—N—S band indicated mitigated LiFSI salt dissociation. Such signals from the DPE-containing electrolytes ranged from 751 and 753 cm⁻¹, suggesting a minimum shift with increasing concentration, while DEE showed a slight shift from 746 to 752 cm⁻¹. However, significant band evolution occurred in DME (716 to 750 cm⁻¹) and DIG (720 to 740 cm⁻¹) electrolytes. Meanwhile, weaker solvating power also led to abundant free solvent molecules regardless of concentrations. Free solvent signals were well detected in DEE and DPE-containing electrolytes up to the highest salt concentration. Unlike DME and DIG systems, the two WSEEs exhibited a minor Li+-ether interaction band at around 874 cm⁻¹. Specifically, deconvoluting results of S—N—S bands from 1.8 M electrolytes in FIG. 2F indicate a large dissociation degree of DME (83.4%) and DIG (86.1%) electrolytes while no free anions existed in DPE and DEE. NMR results of the four electrolytes in FIG. 2G also reveal the same tendency. The noticeable upfield (more negative) shift in ⁷Li signals from DME and DIG-containing electrolytes compared to WSEEs (DPE and DEE-containing electrolytes) suggested strong Li+-ether coordination. Stronger interaction with anions in DPE caused an upfield shift compared to DEE as similar with the upfield shift of DME compared with DIG, which also confirmed its strengthened ion aggregation and strong Li+-Li+ and Li-anion interactions, as evident from the MD coordination numbers shown in FIG. 2H.

Overall, the experimental results were well-correlated with MD simulations. Highly nonpolar ethers such as DPE with largely reduced binding energy to Li+ can easily suppress salt dissociation and facilitate forming ion aggregates starting from 1 M concentration. The Li+-anion coordination in dilute DPE was even more intense than in the highly concentrated DME-containing electrolyte. On the other hand, the fact that the anions undertook coordination to Li+ also implied the existence of more abundant free ether molecules which are predominantly regarded as the critical factor of low stability. With these intriguing results, further investigations were performed to interpret such significantly improved high-voltage stability, especially considering the most stable DPE-containing electrolyte is the richest in free ether molecules. The improved performance was attributed to the following possible reasons, whose contributions and coupled interplay will be assessed in below. First, the CEI layer formed in WSEEs may be extraordinarily robust, which can prevent the parasitic reactions of the ether molecules on the cathode surface. Second, monodentate ether molecules may be more intrinsically stable than other ethers, which suppresses oxidation reactions. Third, the unique solvation behavior of the DPE-containing electrolyte may enable a different degradation pathway and interfacial behavior on the cathode surface to improve the stability.

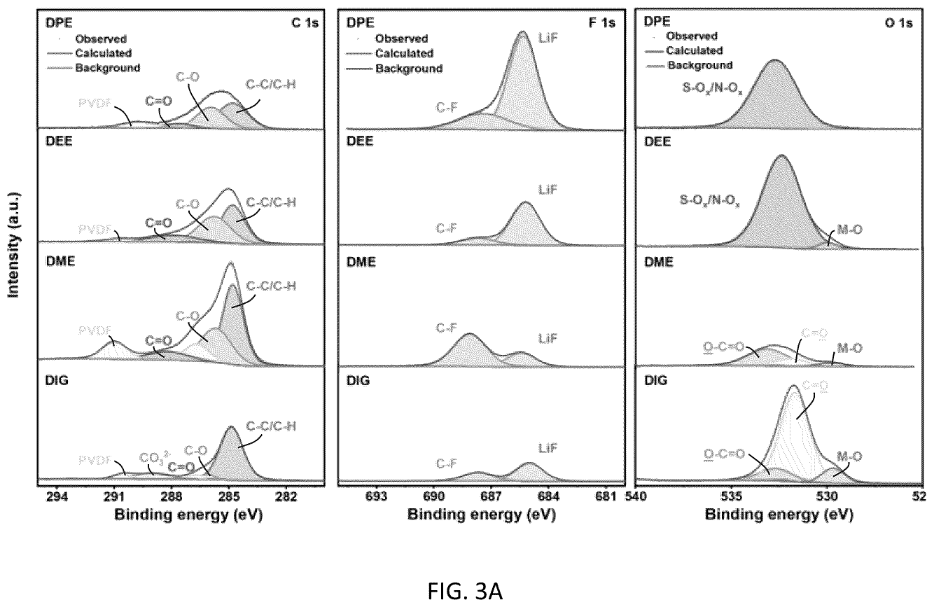

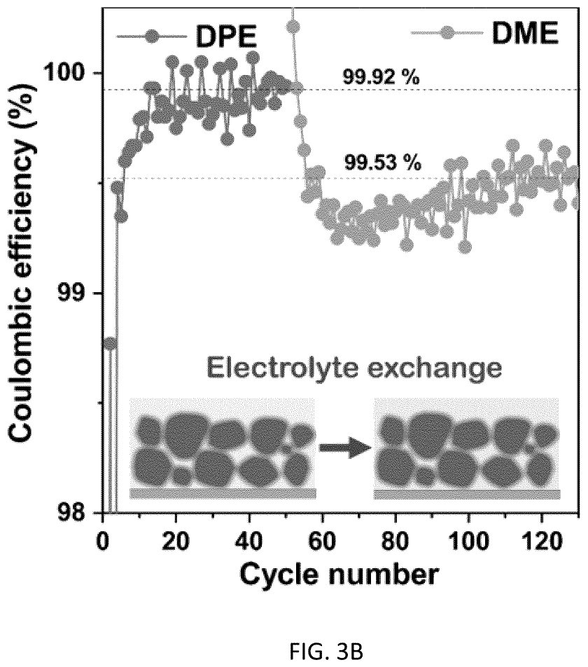

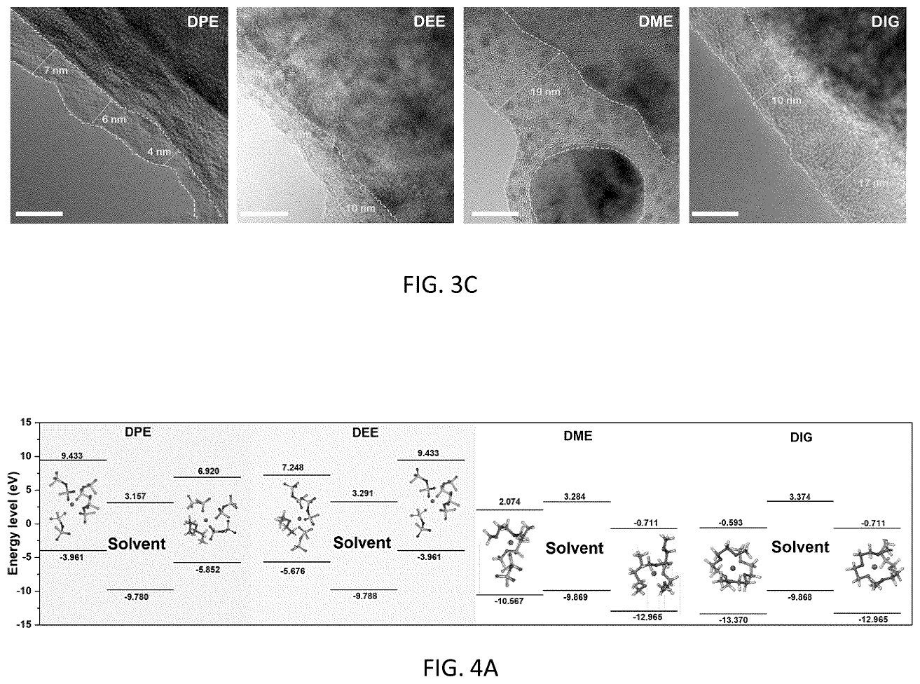

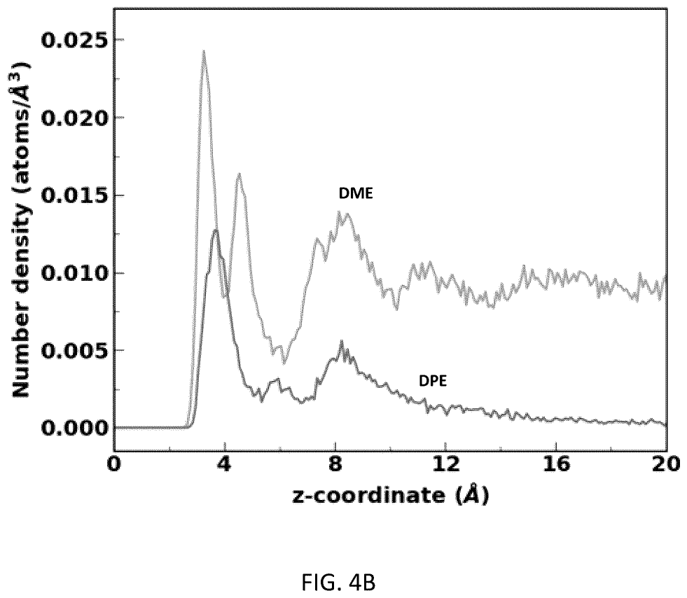

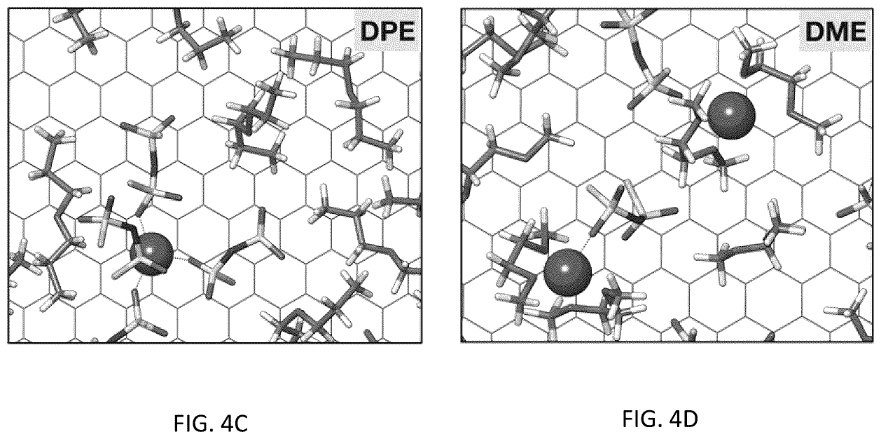

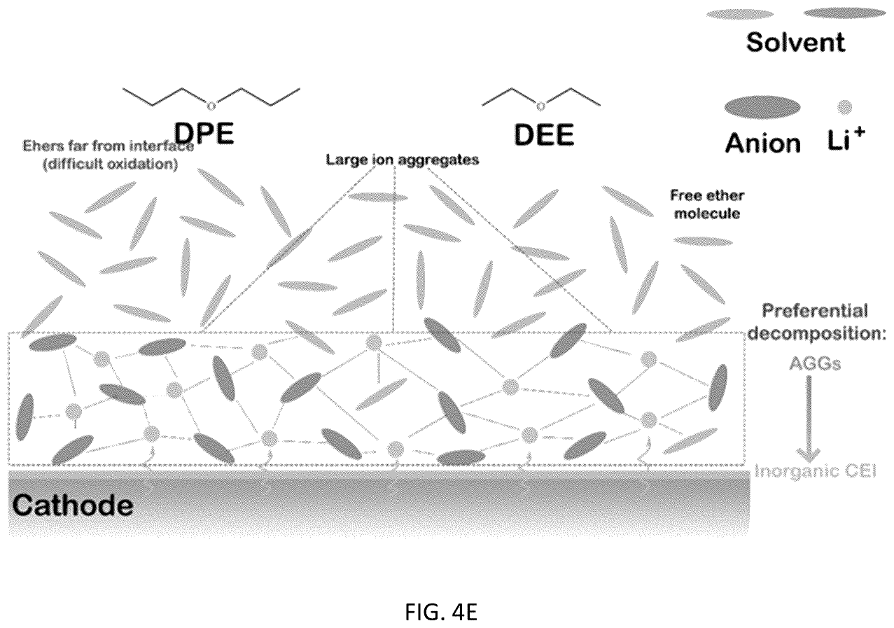

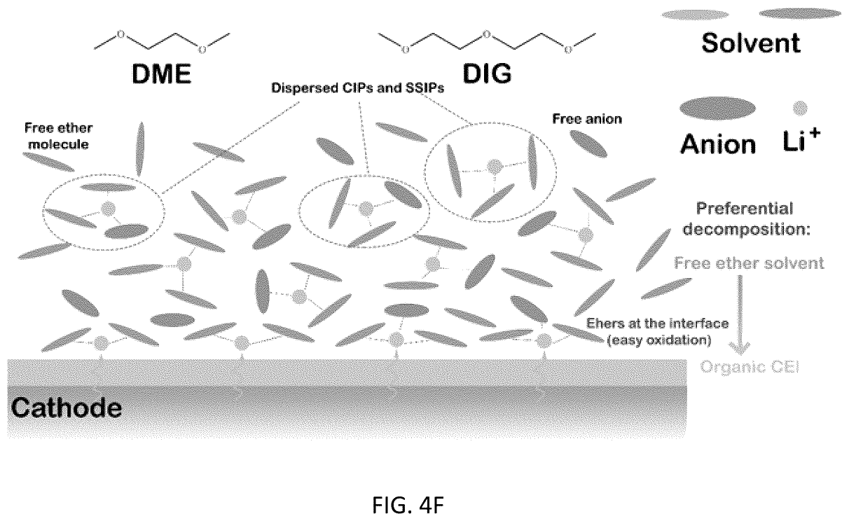

Cathode passivation and the influence on ether oxidation: The cathode passivation due to CEI formation was studied since it has been reported as the primary origin of the cathode stability. An inorganic-rich CEI usually reduces cathode parasitic reactions such as electrolyte oxidation, cathode phase change, and transition metal dissolution. Depth-dependent X-ray photoelectron spectroscopy (XPS) was employed to identify the interfacial chemical species of NCM811 cathodes after 100 cycles from different electrolytes. Atomic concentrations of each cathode were determined, in which the DPE-containing electrolyte displayed an F-rich (about 43%) passivation layer. In contrast, cathodes from DME and DIG-containing electrolytes were covered by abundant carbon and oxygen species. Fine spectra deconvolution analyses in FIG. 3A suggest LiF is the dominant CEI compound from DPE-containing electrolyte. In contrast, the polar electrolytes generated an organic-rich surface layer with abundant C—O (286.15 eV) and C═O (287.8 eV) species. Additionally, only the DPE-containing electrolyte exhibited complete cathode passivation, where the metal oxide signal (M—O, about 529 eV) was not observed. S—Oₓ was detected as the exclusive chemical species in the surface layer, which demonstrated the complete anion-derived CEI in the DPE sample. Depth-dependent profiles showed gradually increasing lattice oxygen concentration as Ar sputtering proceeded, which indicated that DPE formed a thin and uniform surface layer on an NCM cathode. Mn 2p signals were also only undetected in the DPE sample, with the intensity order of DPE<DEE<DIG<DME. These results confirmed improved cathode passivation with low polarity ethers. Prominent signals of S 2p in the DPE and DEE cathodes also verified the anion decomposition. Abundant SOₓF_{y} species at about 170 eV reflect the direct degradation of FSI− anion on the cathode surface. High-resolution TEM was also used to investigate the CEI formation on cathodes after 100 cycles. In FIG. 4F, the DPE and DEE-containing electrolytes exhibit thin and compact surface passivation layers with an average thickness of 5 nm and 8 nm, respectively. The DPE-containing electrolyte especially showed crystalized inorganic species due to the anion decomposition, which is well-correlated with the XPS results. On the other hand, thick and amorphous layers were found on the DME (about 19 nm) and DIG (about 15 nm) cathode surfaces. This demonstrated that these electrolytes cannot passivate the NCM cathode with the abundant organic products to prevent continuous parasitic reactions. Moreover, isolated small NCM particles were also observed in the DME sample, which verified the inferior protection from its CEI and the resulting cathode pulverization.

To assess the contribution of the passivation layer to preventing ether oxidation, electrolyte exchange studies were performed on the cycled electrodes. After 50 cycles in 1.8 M DPE-containing electrolyte, a NCM 811 cathode was harvested from the coin cell and then coupled with 1.8 M DME-containing electrolyte for further cycling. Interestingly, FIG. 3C shows that the known incompatible electrolyte (1.8 M DME) can cycle stably and generate obviously improved cathode CE with a pre-passivated cathode compared to a pristine cathode (99.53% vs. 98.54%). However, the contribution of CEI still could not bring it to the same stability level of DPE results (99.92%). Such offset was confirmed with a DME-HCE system, where a DME-HCE cathode passivation also could not completely block dilute ether oxidation (CE shifting from 99.71% to 99.34% after exchange). These results highlighted the significant role played by a robust cathode passivation. These results also suggested that the surface layer has more prominent kinetic suppression on the reactions that in-situ yield the CEI. The improved anodic stability of the DPE-containing electrolyte on the NCM cathode appears to be a result of synergy between CEI and solvation structure, whose degradation yields the surface passivation. In other words, the stability of a DPE-containing electrolyte with abundant free molecules cannot be simply attributed to outstanding passivation. After all, if the surface layer could largely block DPE degradation, free DME molecules should also be protected after electrolyte exchange. Additionally, the question still existed of how a DPE-containing electrolyte could form an anion-derived CEI despite the enriched free ethers, which are always regarded as the vulnerable species. Further, it was unclear as to why the DPE molecules were not preferentially decomposed in the first place, just like the polar DME and DIG systems.

Electrolyte oxidation behavior and kinetically stabilized interface: Resorting to DFT analyses, the decomposition behaviors of the four electrolytes were studied in terms of the electrochemical stability of their solvation structures. Existing DFT studies tend to explain the stability of ether-based electrolytes via the lowest unoccupied molecular orbital (LUMO) and highest occupied molecular orbital (HOMO) energy levels of individual electrolyte components or coordination couples based on simple solvation models. However, complicated coordination scenarios usually change the stability of the electrolyte species, leading to significant offsets. For the anodic behaviors, solvents coordinating to Li+ are usually characterized by higher stability due to a lower HOMO energy level. Such phenomenon is fundamental in developing HCEs, since the oxidation stability can be essentially improved when most of the free molecules get coordinated. In the present case, the dominant solvation structures in the electrolytes were directly extracted from MD simulations to compute the HOMO/LUMO energy levels, instead of relying on chemical intuition to build possible initial structures. Therefore, the results reflect the genuine oxidation stability and degradation behaviors within different systems.

FIG. 4A presents the LUMO and HOMO energies of free solvents as well as their corresponding top two, most-probable solvation structures from MD simulations. The studied ether molecules have very close HOMO energy levels (within 0.1 eV), suggesting their comparable oxidation stability. Therefore, the oxidation stability of the individual solvent molecules could not explain the improved stabilities in the DPE and DEE-containing electrolytes. However, stark differences originated from the relative positions of the energy levels of the solvation structures compared to the solvents. The strongly anion-involved solvation structures (AGGs) in WSEEs especially in the DPE-containing electrolyte bring their HOMO levels above that of free solvents, resulting in their preferential degradation. As Raman spectroscopy and MD simulation results suggest that Li+-FSI− AGG structures prevail over other solvation structures, its decomposition should dominate passivation reactions during the CEI formation process, consequently forming an inorganic LiF-rich CEI and finally leading to complete cathode passivation. Therefore, the reaction equilibrium shifts to the left so that the entire electrode-electrolyte interface is kinetically stabilized. On the other hand, dilute DME and DIG-containing electrolytes fail to stabilize the interface since ether molecules are competitively coordinated to Li+ but only in small fractions. The majority of ethers are free in the solution and exhibit slightly higher HOMO levels compared to their corresponding solvation structures, and are thus more prone to oxidation. However, these oxidation reactions yield organic products, as demonstrated in our XPS results, that cannot passivate the cathode reaction sites to prohibit continuous oxidation.

The unique AGG-enriched solvation in the DPE-containing electrolyte also indicated an additional contribution from the interfacial behaviors of ionic clusters. In DPE, the anion preferentially makes the Li+ coordination including the released Li+ from the cathode during battery charge owing to solvent's low coordination power. Also considering the positively charged cathode and its attraction to FSI−, Li+-anion aggregations should occupy the surface, repulsing free ether molecules and preventing their direct contact with the cathode surface, which can further mitigate their oxidation. To demonstrate the hypothesis, interfacial MD simulations were performed on the cathode surface to determine the ion and solvent distribution in the electrical double layer (EDL). Comparing the polar DME-containing electrolyte with the nonpolar DPE-containing electrolyte in FIGS. 4B-4D, the amount of ether molecules in the EDL of DPE is obviously diminished, which is beneficial for suppressing the direct oxidation of ethers on cathode surface. Meanwhile, the DPE-containing electrolyte also maintains the ion aggregation behavior in the EDL that Li+ is coordinated by multiple FSI−, as evident from the image in FIG. 4C. Its preferential decomposition leads to the formation of anion-derived CEI layer as demonstrated in the prior sections. In the opposite case, DME solvent molecules were enriched in the EDL over the entire studied distance range. Since most of the DME molecules are uncoordinated to Li+ due to the low concentration and cation repulsion effect on the cathode surface, they are very susceptible to oxidation. These results can also interpret the phenomenon from the electrolyte exchange studies. Despite the well-formed CEI layer via cycling in the DPE-containing electrolyte, the intrinsic solvent-rich EDL structure of the DME-containing electrolyte failed to prohibit the ether oxidation so that the CE of pristine DPE-containing electrolyte could not be reproduced after the exchange. However, the CEI originating from the DPE-containing electrolyte still demonstrated its extraordinary contribution to protect the electrolyte by increasing the CE by 0.99%. Therefore, the results confirmed the synergistic effect between the solvation structure of the electrolyte and the corresponding CEI in improving the anodic stability, as summarized in FIGS. 4E and 4F. Such conclusion would also appear to be valid in other electrolyte systems such as the concentrated DME-containing electrolyte, which was also confirmed by the similar electrolyte exchange study.

Finally, it should be noted that stabilizing the NCM811 cathode in the DPE or DEE-containing electrolytes is considered as a kinetic approach, as the oxidation stabilities of the solvents are hardly improved with less coordination to Li+ than in the DME or DIG systems. FIG. 4A shows that the primary species in the DPE and DEE-containing electrolytes have similar or higher HOMO energy levels than in the DME and DIG systems, indicating their lower thermodynamic oxidation stability. The four studied electrolytes also exhibited very similar degradation potential on an inert Pt electrode, which is even closer to 1 M LiFSI in DME (but with different decomposition pathway and products). However, as demonstrated, unimproved thermodynamic stability does not necessarily lead to incompatibility with high-voltage cathodes and deteriorated parasitic reactions. In fact, 1.8 M DPE-containing electrolyte exhibited higher cathode CE than 4.8 M DME, as discussed above. Therefore, a very effective approach was demonstrated to enable high-voltage operation from dilute ether-based electrolyte, also considering other outstanding performance in preventing the Al current collector corrosion and transition metal dissolution.

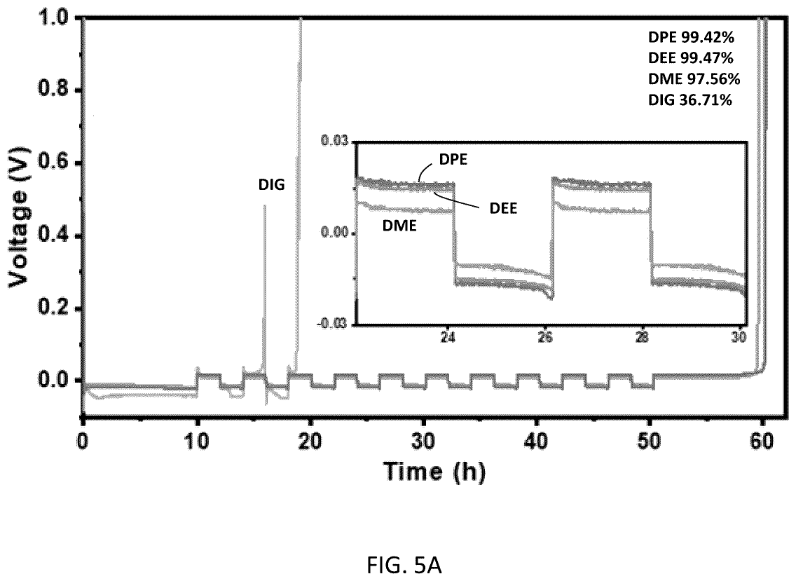

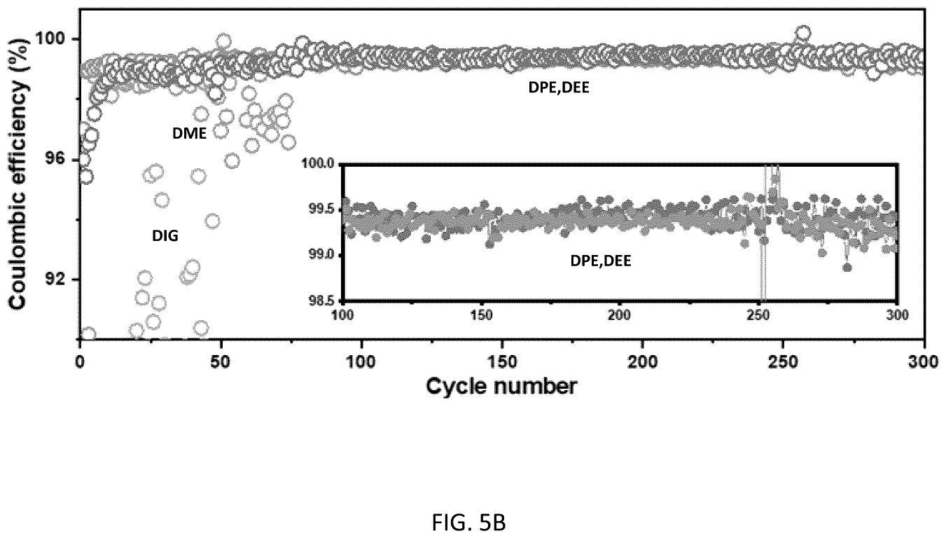

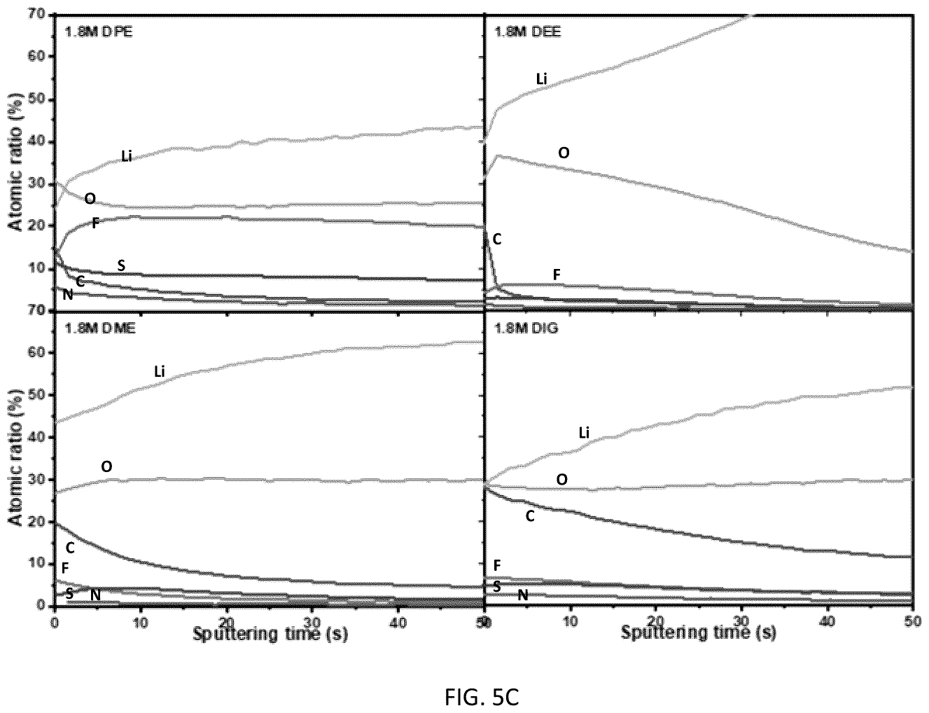

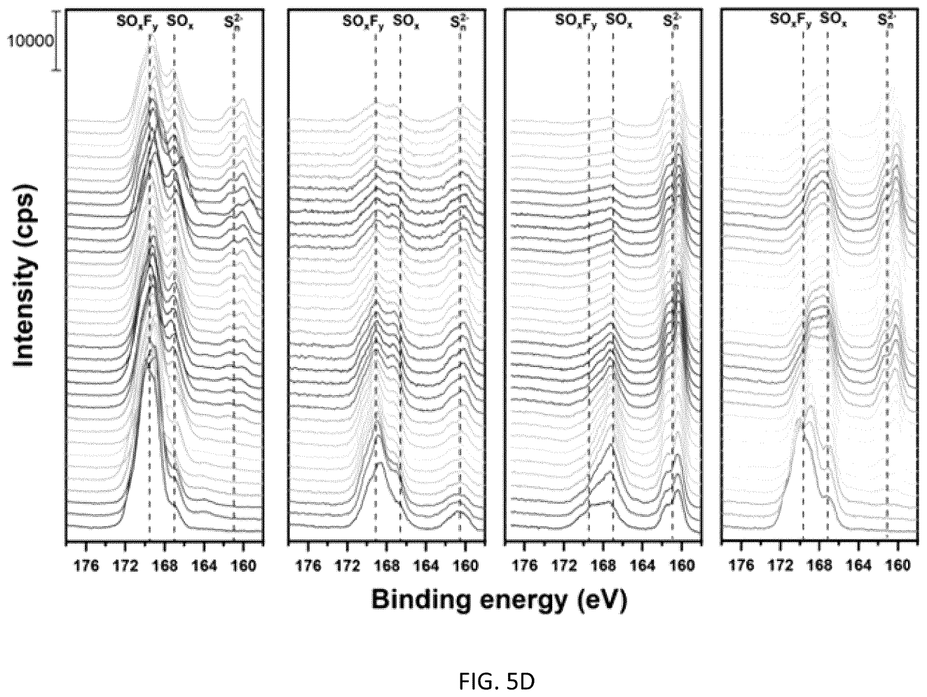

Compatibility with Li metal anode: Reversible Li metal deposition and stripping processes are critical in facilitating the stable cycling of LMBs. The impact of the solvation structures was therefore investigated. Using the modified Aurbach method, FIG. 5A displays the CE of LMA, where 99.42% and 99.47% are determined from DPE and DEE-containing electrolytes, respectively. With stronger solvation power, the DME-containing electrolyte exhibited less efficiency of 97.56%, while the DIG-containing electrolyte was unsuitable in stabilizing the anode interface with 36.71% efficiency. The results demonstrated the superior Li metal compatibilities of DPE and DEE-containing electrolytes, which was also comparable to the efficiencies of other state-of-the-art electrolytes. The DME-containing electrolyte showed lower overpotential (about 16 mV) than DPE and DEE (about 26 mV), concluded to be mainly due to its high conductivity. A long cycle stability test of Li metal anode was performed with Li∥Cu cells. As shown in FIG. 5B, DPE and DEE-containing electrolytes successfully demonstrated 300 stable cycles with an average efficiency of 99.45% starting from the 100th cycle. In contrast, the other two electrolytes caused battery failure within 60 cycles. XPS studies of the Li anodes with depth-dependent analyses also identified the improved interfacial passivation with nonpolar ether-based electrolytes. The Li anode from half cells were harvested and tested after 100 cycles. The LMA from the DPE-containing electrolyte exhibited very consistent elemental concentrations throughout the SEI in FIG. 5C, which suggested homogenous elemental distributions. The SEI also consisted of much more abundant fluorinated species (about 22%) compared to other electrolytes. This indicated that the DPE-containing electrolyte largely enabled the anion-originated SEI formation. The DME and DIG-based electrolytes, on the other hand, contained more organic carbon species. Fine XPS spectra analyses in FIG. 5D provide more detailed insights regarding the SEI composition. The highest intensity of S 2p signal from the DPE-containing electrolyte verified the preferential decomposition of the anion and the formation of inorganic species. Abundant SOₓF_{y} component dominated the reaction products at different depths. The O species was also mainly detected as S—O components with minimum Li₂O. More importantly, chemical compositions are also observed to vary with increasing etching depth from all the studied electrolytes, but to different extents. As etching proceeded, compounds with lower binding energies gradually enrich in the SEI, such as SOₓF_{y}→SOₓ→Sn²⁻ (S 2p); F—N(SO₂)→N(SO₂) (N 1s); S—O→C—O→Li₂O (O1s). This indicated that a more complete reduction occurred approaching the metallic Li. Among the four electrolytes, the WSEEs like the DPE and DEE-containing electrolytes featured much less SEI component variations in different depth, which significantly improved the Li metal passivation and reduced parasitic reactions. The Li deposition efficiency can thus be enhanced compared to DME and DIG. Li metal deposition morphology studies via SEM verified the improved plating behavior when decreasing the solvating power. DPE and DEE achieved uniform Li deposition on a Cu substrate with a large Li grain size. Their cross sections indicated dense Li packing with minimal cracking and porous structures. The DME-containing electrolyte showed nonuniform plating where the substrate could be observed. Due to the lowest LMA CE, the DIG-containing electrolyte hardly plated Li and generated a very thin layer of deposition with obvious dendritic morphology. Improved Li deposition behavior was also due to demonstrated better wettability on the Li metal surface.

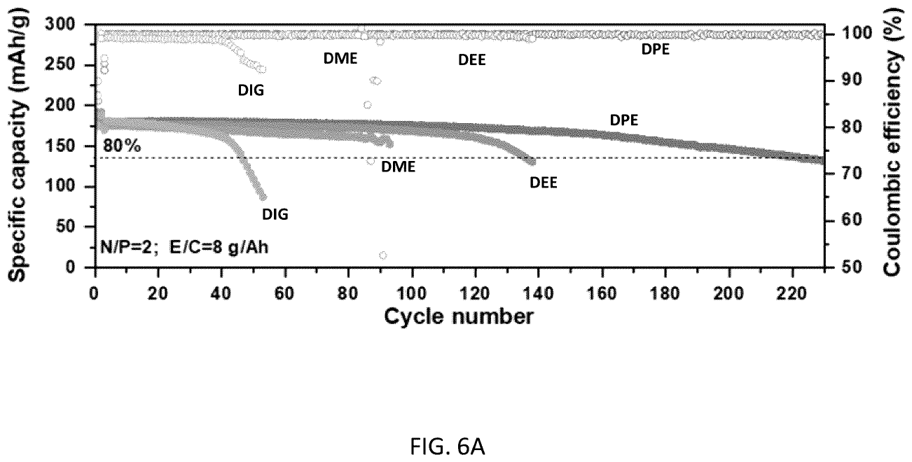

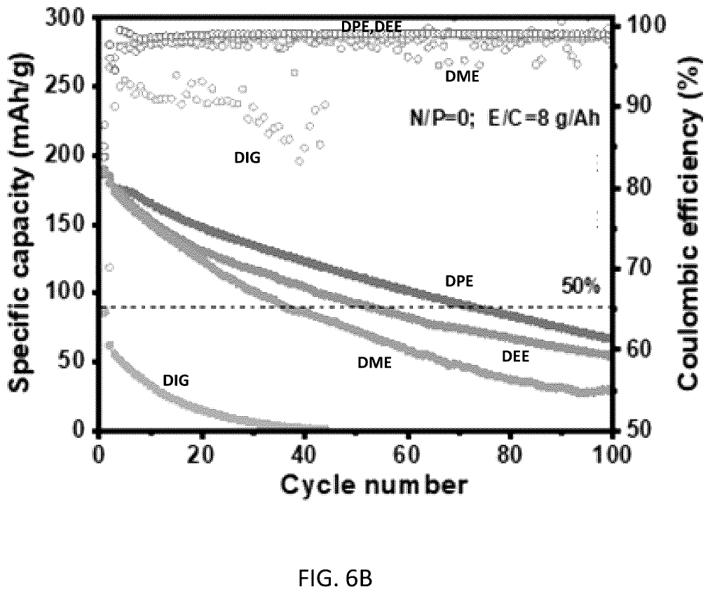

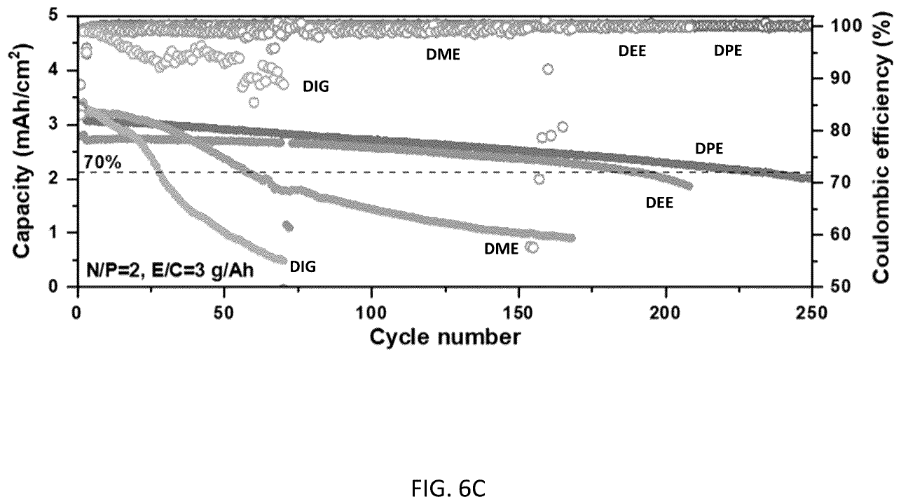

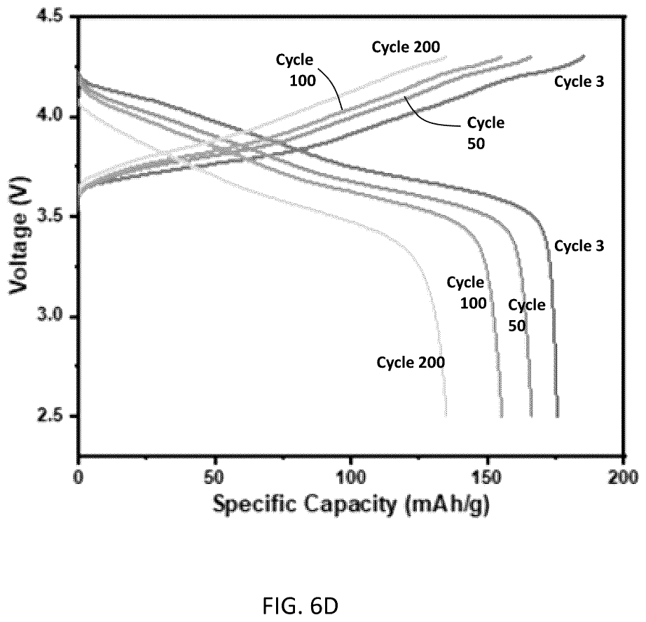

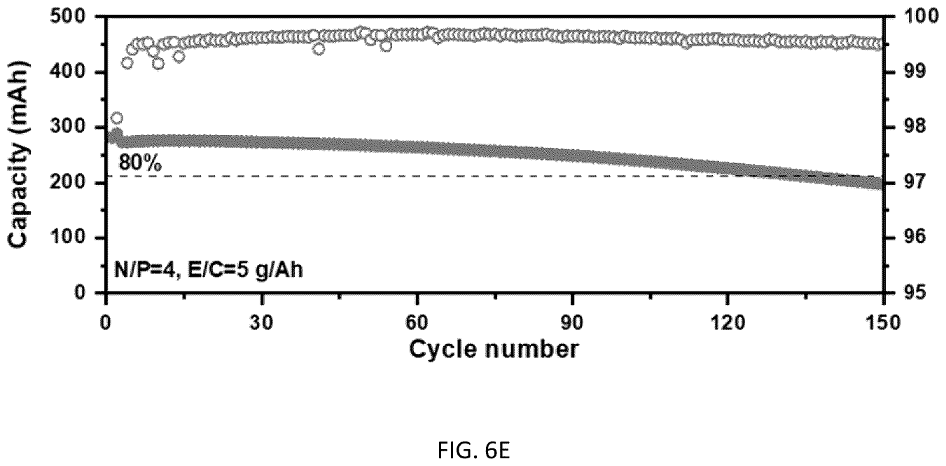

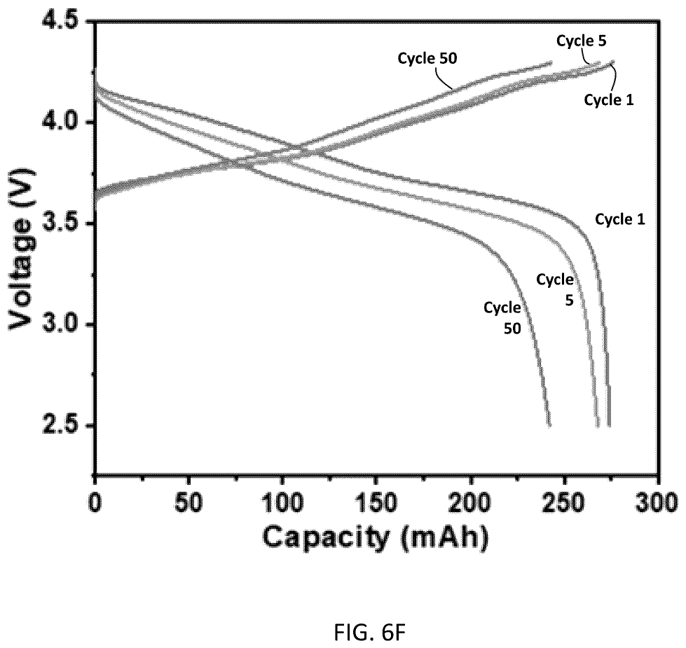

Full cell performance of LMB under practical conditions: The electrochemical performance of the four electrolytes was investigated within practical LMBs under controlled electrolyte and Li anode amount conditions. High loading NCM811 cathodes (about 16.5 mg/cm², 3.3 mAh/cm²) were used in these studies with a 4.3 V high cutoff voltage. To accurately control the Li metal amount, excess Li was electrochemically deposited (N/P ratio=²) and used as anodes in coin cells. FIG. 6A shows a prolonged cycling stability of LMB with the DPE-containing electrolyte compared to the other three electrolytes. The DPE-containing electrolyte retained 82% capacity after 220 cycles, whereas DME and DIG caused quick battery failure before 100 cycles. The obtained average CE of DPE cell was 99.90%, indicating a well-stabilized cathode electrolyte interface with mitigated side reactions. The 1.8 M DEE-containing electrolyte also delivered improved cyclability but could not outperform DPE due to its suboptimal high-voltage compatibility, as confirmed above. In addition, the DPE-containing electrolyte also enabled long cycling of an LMB under lean electrolyte condition with an E/C ratio of 3 g/Ah. Such a strict scenario mimics realistic LMB operations. The DPE-containing electrolyte still demonstrated unprecedented results of retaining 80% capacity after 172 cycles in FIGS. 6C and 6D. Additionally, the LIB full cell with the same cathode and a graphite anode delivered 1000 stable cycles with an average CE of 99.95%, which verifies minimum ether oxidation and the formation of a robust CEI. With the advantage of weak coordination to Li+, the DPE-containing electrolyte can also facilitate low temperature performance with high voltage cathode, delivering 61% of room temperature capacity under −40° C. Other conditions such as anode-free full cells (FIG. 6B) also verified an improved interfacial stability from the DPE-containing electrolyte compared to the others evaluated electrolytes according to an improved capacity retention and full cell efficiency.

Finally, 300 mAh LMB pouch cell prototypes were built with the DPE-containing electrolyte to assess its performance in large-size batteries with moderate stacking pressure (around 30 PSI, 200 KPa). As shown in FIGS. 6E and 6F, the pouch cell delivered impressive stability of 88.6% retention after 100 cycles and 74.1% after 150 cycles. Overall, the abovementioned electrochemical performance evidenced a great potential for using a dilute DPE-containing electrolyte for practical high voltage LMBs.

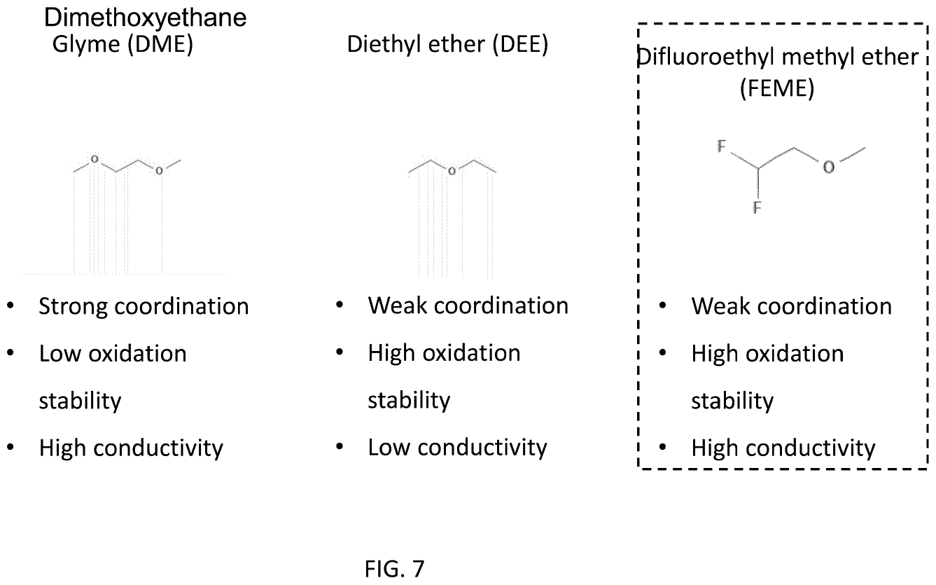

FIG. 7 graphically compares characteristics of ether molecules of DME, DEE, and FEME. These characteristics evidence that fluorinating the ether molecule can change the coordination power and intrinsic oxidation stability at the same time. An optimized balance between ionic transfer and interfacial stability is expected to be achieved. The liquid electrolyte with the FEME solvent features high ionic conductivity, anode and cathode compatibility as well as small interfacial resistance. It can enable high performance of high-voltage Li metal batteries, especially at low temperatures.

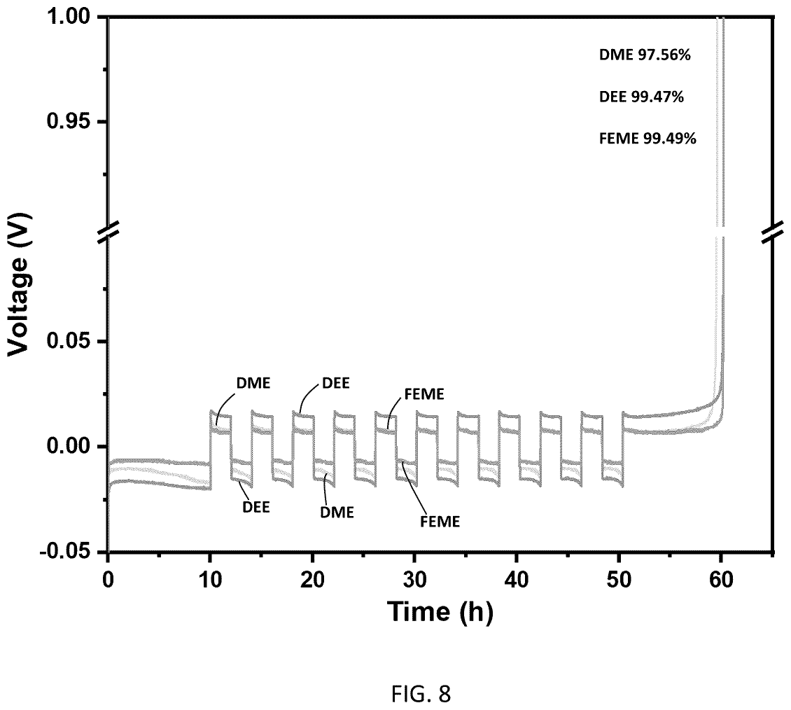

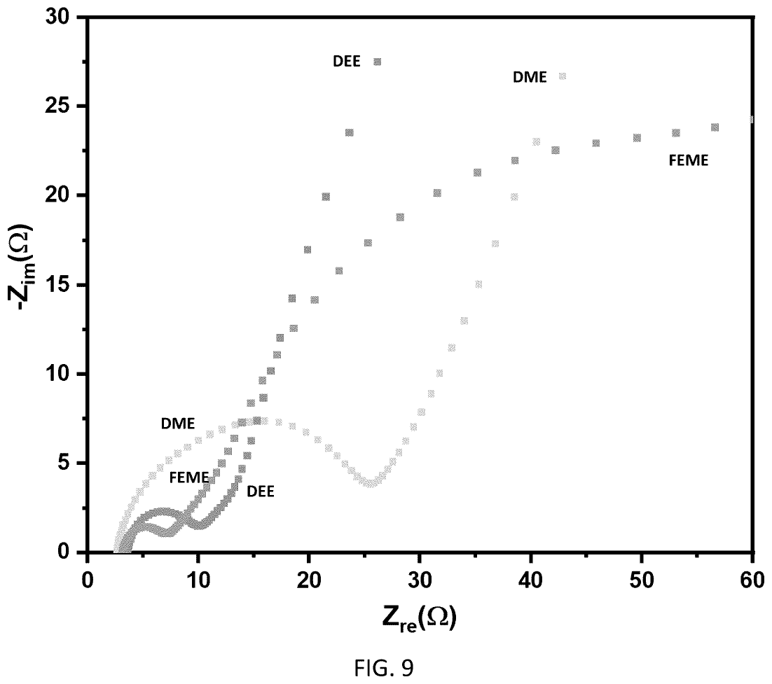

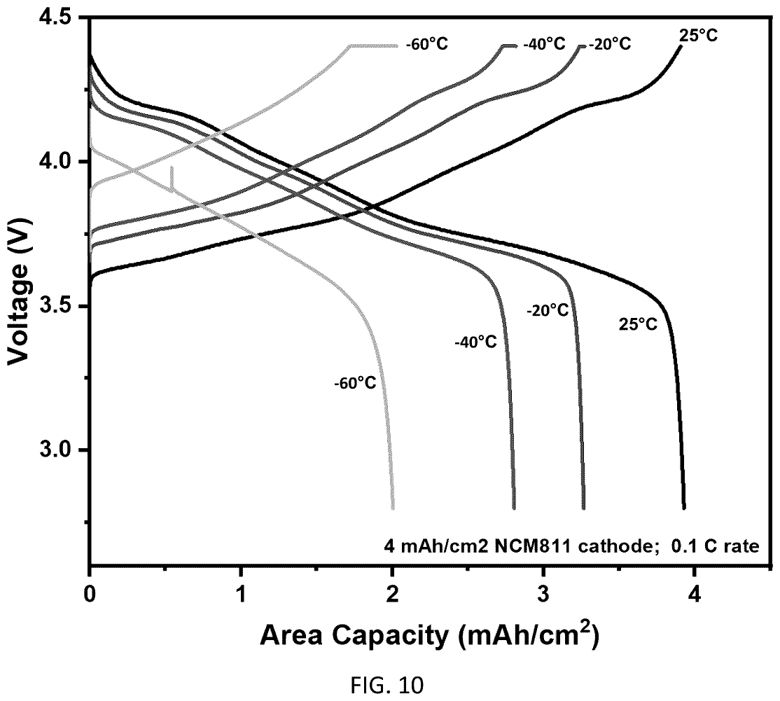

FIGS. 8, 9, and 10 contain graphs comparing the electrochemical performance of DME, DEE, and FEME-containing electrolytes. FIG. 8 plots Li metal anode compatibility, FIG. 9 plots interfacial impedance, and FIG. 10 plots low temperature performance of a full cell. Compared to the DME and DEE-containing electrolytes, the FEME-containing electrolyte exhibits high coulombic efficiency of Li metal plating (99.49%) and ultra-low polarization (16 mV), ultra-low interfacial impedance with Li metal anode (5.2Ω), and excellent low temperature performance of practical Li metal battery. (72.1% and 50.1% capacity retention at −40 and −60 degree Celsius).

The above investigations demonstrated a successful strategy for improving high-voltage compatibility of dilute (<2 M) ether-based lithium electrolytes by using the highly nonpolar ether solvent, and yet other investigations demonstrated that the strategy can also be successful with dilute ether-based lithium electrolytes of less than 3 M. Low concentration and nonfluorinated electrolytes based on a DPE solvent and LiFSI salt were shown to significantly extend the high voltage (4.3 V) operation of LMBs with commercially viable battery configurations (high loading cathode, controlled anode, and electrolyte amount). Due to an ultra-weak coordination ability to Li+, the DPE based electrolyte features an anion-induced, ion aggregation enriched Li solvation behavior. DPE tunes the relative HOMO energy level of aggregated solvate species and rearranges the decomposition order of electrolyte components at the cathode interface. The preferential degradation of ion aggregates was concluded to circumvent the oxidation of free ether molecules and lead to a robust anion-derived CEI layer which kinetically stabilizes the interface for solvent molecule. The unique aggregated Li solvation structure displaces the ether molecules in the EDL, leading to a solvent-deficient interfacial regime and a synergistically enhanced ion transfer process, thereby providing an excellent cathode CE of 99.90% using the DPE electrolyte. Coin cells utilizing the DPE-containing electrolyte retained 82% capacity after 220 cycles, and the practical pouch cell also demonstrated 150 stable cycles with 74.1% retention. Conclusions from these investigations suggest a viable approach to overcome inferior solvent stability of ether-based electrolytes with high-voltage cathodes by modulating the locally controlled and dynamically changing solvation structure rather than, for example, the traditional approaches such as ultra-high salt concentrations or ether fluorination process. This approach differs from conventional electrolyte design principles. By tuning the solvation phenomena, an effective electrolyte design parameter was established that can establish a kinetically controlled interface and effectively mitigate cathode side reactions to enhance LMB operations.

As previously noted above, though the foregoing detailed description describes certain aspects of one or more particular embodiments of the invention and investigations associated with the invention, alternatives could be adopted by one skilled in the art. As such, and again as was previously noted, it should be understood that the invention is not necessarily limited to any particular embodiment described herein or illustrated in the drawings.

1. An ether-based electrolyte for a lithium metal battery, the ether-based electrolyte comprising a highly-nonpolar, nonfluorinated dipropyl ether (DPE) solvent that enhances the oxidation stability of the lithium metal battery.

2. The ether-based electrolyte according to claim 1, wherein the DPE solvent enhances the oxidation stability by adjusting the interfacial decomposition sequence and modifying the electric double layer structure of the lithium metal battery.

3. The ether-based electrolyte according to claim 1, wherein the ether-based electrolyte further comprises an imide-type salt.

4. The ether-based electrolyte according to claim 3, wherein the imide-type salt is lithium bis(fluorosulfonyl) imide (LiFSI) or lithium bis(trifluoromethanesulfonic)imide (LiTFSI).

5. The ether-based electrolyte according to claim 3, wherein the imide-type salt has a concentration in the ether-based electrolyte of less than 3 M.

6. The ether-based electrolyte according to claim 3, wherein the imide-type salt has a concentration in the ether-based electrolyte of less than 2 M.

7. A lithium metal battery comprising:
an anode;
a cathode; and
an ether-based electrolyte electrochemically coupling the anode with the cathode, wherein the ether-based electrolyte comprises a highly-nonpolar, nonfluorinated dipropyl ether (DPE) solvent that enhances the oxidation stability of the lithium metal battery.

8. The lithium metal battery of claim 7, wherein the battery operates at a voltage of greater than 4 V.

9. The lithium metal battery of claim 7, wherein the cathode comprises a nickel-rich cathode.

10. The lithium metal battery of claim 7, wherein the anode comprises a lithium metal negative electrode.

11. The lithium metal battery of claim 7, wherein the cathode comprises a LiNi_{0.8}Co_{0.1}Mn_{0.1}O₂-based positive electrode.

12. A method comprising using an ether-based electrolyte as a battery electrolyte of a lithium metal battery, wherein the ether-based electrolyte comprises a highly-nonpolar, nonfluorinated dipropyl ether (DPE) solvent that enhances the oxidation stability of the lithium metal battery.

13. The method of claim 12, further comprising forming a solvent-deficient electric double layer on a cathode surface of the battery using the ether-based electrolyte to inhibit oxidation of the ether-based electrolyte.
